(19) United States
(12) Patent Application Publication
(10) Pub. No.: US 2013/0339072 A1
(43) Pub. Date: Dec. 19, 2013

(54) ELECTRIC VEHICLE CHARGE SCHEDULING METHOD AND CHARGE SCHEDULING DEVICE

(71) Applicant: Hiroshi Touge, Ichinomiya-shi (JP)

(72) Inventor: Hiroshi Touge, Ichinomiya-shi (JP)

(73) Assignee: AISIN SEIKI KABUSHIKI KAISHA, Kariya-shi, Aichi-ken (JP)

(21) Appl. No.: 13/989,593

(22) PCT Filed: Dec. 9, 2011
(86) PCT No.: PCT/JP2011/078561

§ 371 Date: May 24, 2013

(30) Foreign Application Priority Data
Dec. 15, 2010 (JP) 2010-279152

(51) Int. Cl. G06Q 10/02; G06Q 50/30; B60L 11/18

(52) U.S. Cl. CPC G06Q 10/02; B60L 11/1838; G06Q 50/30
USPC 705/5

(57) ABSTRACT

A method for battery charge scheduling for an electric vehicle including a position confirming step for confirming a position of the vehicle, a candidate station obtaining step for obtaining information on position of the candidate battery charge station, a waiting time and a battery charge cost, a candidate battery charge station displaying step for displaying the information of the candidate battery charge stations, a candidate battery charge station selecting step for selecting a candidate battery charge station at which a battery charge is desired to be carried out and a battery charge reserving step for reserving the battery charge at the candidate battery charge station through the station control network based on a setting at the candidate battery charge station selecting step through the in-vehicle information device. By this method, user convenience is improved and actual risks and mental anxieties derived from low battery charge can be relieved or removed.

### TECHNICAL FIELD

This invention relates to a method for and a device of scheduling battery charge timing for an electric automobile or an electric vehicle at a battery charge station equipped with a battery charge facility.

### BACKGROUND OF THE TECHNOLOGY

Recently, an electric vehicle has been gradually becoming popularized and the battery charge equipment for charging battery of such electric automobiles has been now gradually developed and maintenance of charge stations for public use is being in progress. However, at present, the mileage of the electric automobile or vehicle is not so good compared to that of other vehicles, such as a gas driven car, a diesel driven car or a liquefied natural gas (LNG) driven car and further the number of the equipment of the battery charge for the electric vehicle is less than the number of the gas station for the other vehicles. Due to such situations, when one drives away with an electric vehicle, it is necessary for the operator of the vehicle to carefully watch where a battery chargeable station is or to always keep in mind the battery charge locations when or before going out so that a proper timing battery charge can be made before a serious shortage of battery occurs. Many users of the electric vehicle concern about the battery shortage which might occur any time due to a bad traffic condition or running on an unfamiliar road. Further, in addition, since the battery charge takes a longer time compared to the time for filling gas to a gas driven car, an issue arises how an operator of the electric vehicle spends the time during a battery charging. In order to cope with or to measure against such restrictions, concerns or inconveniences, various systems have been developed to offer benefits for the users of the vehicle regarding to the battery charge.

As disclosed in a Patent Document 1, the secondary battery (in-vehicle battery) supply system is provided with a secondary battery management device, a total management device and information providing device assuming that the secondary battery is exchanged upon supply of an in advance pre-charged secondary battery, not to charge the secondary battery every time when a battery becomes low to be charged. The secondary battery management device is provided at a battery charge facility and manages to control a battery charge condition for a plurality of secondary batteries and sends the information on availability of supply of the secondary battery and the available number thereof to the total management device. The total management device manages to control a plurality of the secondary battery management devices and sends the available secondary battery charge facilities in response to the inquiries from the information providing device. The information providing device provides the inquiries and outputs the information on the battery charge facilities as well. According to such system, the battery charge facility information reflecting the availability of a particular facility and the requests from the user is said to be available to the users of the battery charge facilities according to the Patent Document 1.

Further, according to the Patent Document 2, battery charge station information with a server is disclosed. The server provides the users outside with the information on the battery charge stations for the electric vehicles via a communication network system. According to this server, several means are equipped with, which are for example, means for receiving the information of the position of the electric vehicle and the battery remaining amount thereof through the communication network, means for calculating an estimated mileage of the vehicle based on the average mileage data base and means for informing outside users of available battery charge stations existing within the area where the vehicle is expected to arrive by extracting such available stations from the data. According to this system, the operator of the electric vehicle is notified of the information on available battery charge stations existing within the available mileage distance and the operators do not need to worry about the battery shortage (no remaining battery amount shortage occurs).

Further, according to the Patent Document 3, an information transmitting device is disclosed which transmits the information between the vehicle and the external device in one-way or in both ways. The information transmitting device is featured to have a receiving device of the keyless entry system in order to receive information from the external device towards the vehicle and yet the information other than the keyless entry control information. In other words, the receiving device of the keyless entry system is commonly used for receiving information other than the keyless entry. Thus, according to this device, the energy consumption is not increased although information receiving condition is always kept open (ON).

### PRIOR ART DOCUMENT

### Patent Document

Patent Document 1: JP2006-331405 A
Patent Document 2: JP2007-148590 A
Patent Document 3: JP2001-294136 A

### DISCLOSURE OF INVENTION

### Problems to be Solved

It is noted that according to the device disclosed in Patent Document 1, the device needs only the time for exchange the secondary batteries and accordingly it is effective to eliminate the battery charging time. However, according to this method, another issue arises that if the number of secondary battery supply systems is only one existed in a certain area, the information on all electric vehicles needed to supply battery come to this system at one time, and the information processing in the system may delay or the system itself may be broken due to an excess load. This may stop information providing services. If a plurality of such secondary battery supply systems exists in a certain area, it is necessary to individually make access to each system from each electric vehicle, which may be troublesome. Further, at the user side, the information provided from each system has to be compared to select the best available battery charge station. This may also be troublesome.

Further, according to the disclosure of Patent Document 2, the available mileage distance calculated by the server varies greatly depending on the actual running condition of the electric vehicle. For example, if the vehicle is running using the air-conditioner, the in-vehicle battery is rapidly consumed and may become battery shortage condition even before the vehicle reaches within the available mileage distance calculated by the server based on the average mileage distance data base. Accordingly, the information on location of the battery charge stations sent from the server can be used as merely a reference or a guide and actual selection of the battery charge station should be made by the user side in order to eliminate worries about such battery shortage.

Further, the information transmitting device according to Patent Document 3 is effective because no increase of the electric power consumption is expected, but no function for how to select the battery charge stations is provided.

According to the external server type system disclosed in the Patent Documents 1 and 2, although the information on the battery charge station is sent to a user of the electric vehicle from the system side, the request from the user side is not accepted by the system side. In other words, the user of the electric vehicle cannot reserve a battery charge at a desired battery charge station at a desired time based on the scheduled arrival time to the desired station. The battery remaining amount which the user of the vehicle begins to worry about depends on the individuals and it would be impossible to relieve everyone's concerns by merely giving information obtained by a standardized processing provided by the server. Further, the system cannot satisfy the user's appreciation or preference for eating or shopping at a nearby facility while the battery is being charged. On the other hand, if the server is improved to be highly sophisticated in order to resolve the delay of processing due to concentration of access to the server from many users of the electric vehicles, the cost of system increases greatly. Further, according to the system disclosed in the Patent Document 1, the information reflecting battery charge side convenience and requests is provided to the user. This may cause the monopolization of certain facilities at certain areas and eventually may lead to the increase of overall battery charge cost.

The present invention was made in consideration with the above drawbacks and the object of the invention is to provide a battery charge scheduling method and the device therefor for an electric vehicle, wherein the convenience of user is improved by enabling a battery charge scheduling or reservation reflecting individual users' appreciations and preferences and actual risks and mental anxieties derived from the low battery charge can be relieved or removed and wherein the readiness and operation reliability of the system can be improved by sharing processing load of the system with the vehicle side.

### Means for Solving the Problem

According to an aspect of the invention to solve the above conventional problems, the method for battery charge scheduling for an electric vehicle by using a station control network formed by a plurality of station control devices which control a battery charge facility equipped in a battery charge station to mutually exchange information among the plurality of station control devices, each of which is cooperatively associated with one another and an in-vehicle information device equipped in an electric vehicle for information exchange with the station control network is comprised of the following steps: a position confirming step for confirming a current position of the electric vehicle by the in-vehicle information device, a candidate battery charge station obtaining step for listing up candidate battery charge stations based on the current position of the electric vehicle and obtaining information including position of the candidate battery charge station and information including a waiting time and a battery charge cost of a candidate battery charge facility located in a corresponding candidate battery charge station from the station control network into the in-vehicle information device, a candidate battery charge station displaying step for displaying the information of the candidate battery charge stations and the information of the candidate battery charge facilities by the in-vehicle information device, a candidate battery charge station selecting step for selecting a candidate battery charge station at which a battery charge is desired to be carried out and setting a selected candidate battery charge station in the in-vehicle information device and a battery charge reserving step for reserving the battery charge at the candidate battery charge station through the station control network based on a setting at the candidate battery charge station selecting step through the in-vehicle information device.

### BRIEF EXPLANATION OF ATTACHED DRAWINGS

FIG. 1 is a schematically illustrated station control network and the in-vehicle information device to be used for the method for battery charge scheduling for an electric vehicle according to an embodiment of the invention.

FIG. 2 is a flowchart explaining the method for battery charge scheduling for the electric vehicle according to the embodiment.

FIG. 3 is a view illustrating an example of a display on in-vehicle information device at a candidate displaying step.

### THE EMBODIMENT OF THE INVENTION

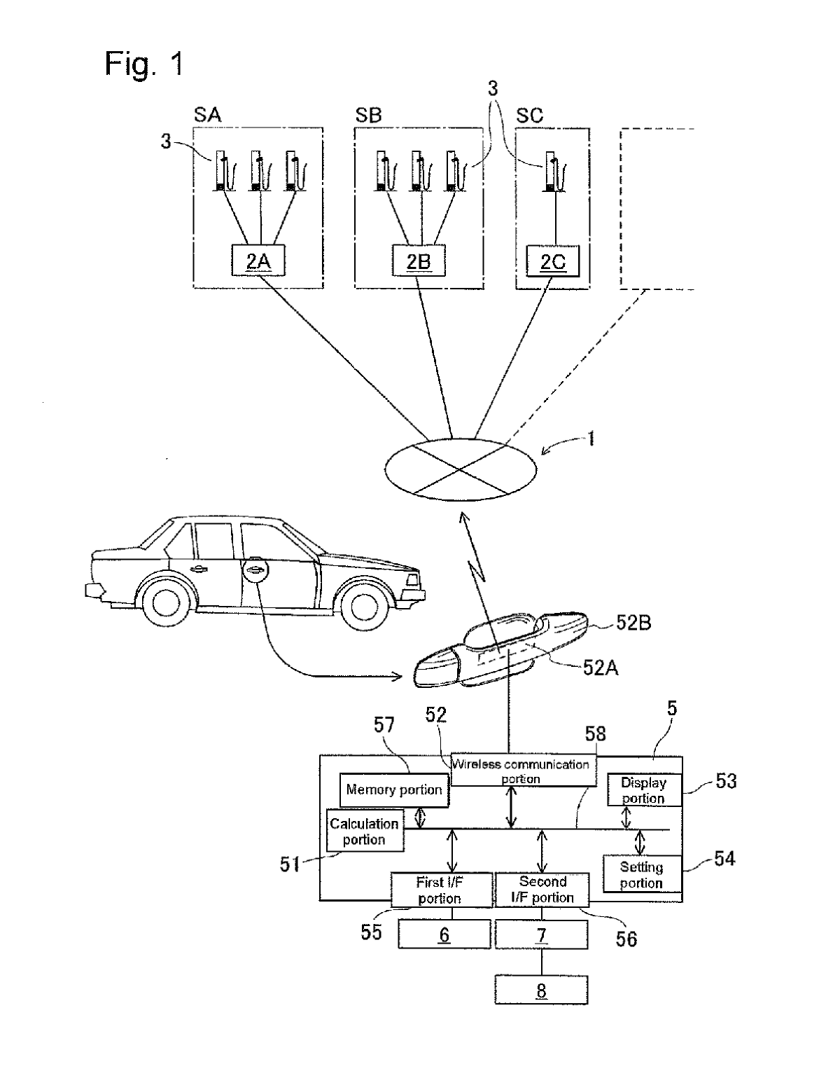

An embodiment of the method for battery charge scheduling for an electric vehicle according to the invention will be explained with reference to the attached drawings, FIGS. 1 through 3. FIG. 1 is a schematically illustrated station control network and the in-vehicle information device to be used for the method for battery charge scheduling for an electric vehicle. As shown in the drawing, the station control network 1 is formed by a plurality of station control devices 2A, 2B and 2C which are mutually cooperative to exchange information therebetween. The in-vehicle information device 5 is installed in an electric vehicle and the information thereof is exchangeable with the information of the station control network 1 through a wireless communication. This structure will be explained in detail hereinafter.

The station control devices 2A, 2B and 2C are provided in respective battery charge stations SA, SB and SC and each device 2A, 2B and 2C controls one or a plurality of battery charge facilities 3 provided in each station. The station control devices 2A, 2B and 2C are formed by, for example, a personal computer which is communicable with each of the battery charge facilities 3 through telecommunication. The station control devices 2A, 2B and 2C confirm operation state of the battery charge facilities 3 and include a scheduling function for controlling the operation state of the battery charge facilities 3.

The station control network 1 uses the telecommunication function as information exchange means and the communication may be either with wire or without wire or combination of the two. Further an exclusive communication line may be used or a public communication line including the Internet may be used. Further, as the control system, a control server for centrally controlling and processing is provided in the network or a system where each station control device 2A, 2B and 2C de-centrally controls and processes.

The in-vehicle information device 5 is formed by a microprocessor. According to this embodiment, the device 5 is formed by a calculation portion 51, a wireless communication portion 52, display portion 53, a setting portion 54, first and second interface portions 55 and 56 and a memory portion 57. The calculation portion 51 includes a microprocessor and is operable by software to control operation of each portion 52 through 57 thereby executing the steps S1 through S7 and S9 and S10 which will be explained later. The wireless communication portion 52 exchange information with the station control network 1 through a wireless communication. An antenna 52A of the wireless communication portion 52 is housed in a door handle 52B of the vehicle and is commonly used with a smart entry system. The display portion 53 is a portion for displaying a various kind of information for an occupant of the vehicle and the portion 53 uses, for example, a liquid crystal display device. The setting portion 54 is a portion for setting by the occupant of the vehicle and the portion 54 uses, for example, a ten-key board input device or a touch panel device.

The first interface portion 55 is a portion for interfacing with the navigation device 6 and the second interface portion 56 is a portion for interfacing with a vehicle control device 7. The vehicle control device 7 functions to observe a battery charge condition of an in-vehicle battery 8 which is an electric power source for a motor (not shown) for driving the vehicle and also functions to calculate an estimated possible travel distance and an average vehicle speed. The memory portion 57 is a portion for memorizing software and data and the memory portion 57 accumulates the battery charge history as will be explained later in detail. Each portion 51 through 57 of the in-vehicle information device 5 is connected to one another by a data bus line 58 for mutually exchanging information.

According to this embodiment, the explanation will be made that the in-vehicle information device 5 and the navigation device 6 are separately formed, but both devices 5 and 6 can be formed integrally.

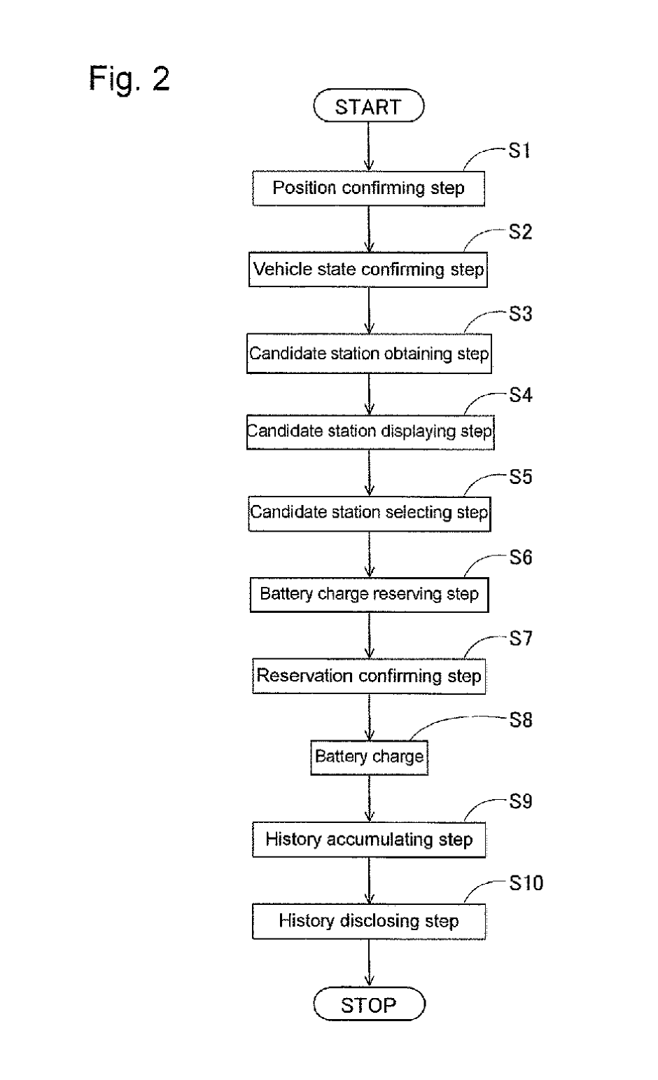

Next, the method for battery charge scheduling for the electric vehicle will be explained hereinafter. FIG. 2 shows a flowchart for battery charge scheduling for the electric vehicle according to the embodiment. First, when an ignition switch of the electric vehicle is turned ON, the in-vehicle information device 5 is turned ON. Then when an occupant of the vehicle sets instructions to activate at the setting portion 57, the operation of the in-vehicle information device 5 is started. Further, when the in-vehicle battery 8, which is under observation by the vehicle control device 7, becomes lower than a preset value, the activation instruction is also set through the second interface portion 56 to initiate the operation of the in-vehicle information device 5.

At the first step S1 for the position confirming step, the in-vehicle information device 5 confirms the current position of the electric vehicle upon receiving information thereof from the navigation device 6. Then at the vehicle state confirming step S2, the in-vehicle information device 5 obtains the information on battery charge condition of the in-vehicle battery 8 and the average vehicle speed from the vehicle control device 7. The in-vehicle information device 5 calculates an estimate possible travel distance based on the battery charge condition of the in-vehicle battery 8. As an alternative way, the estimate possible travel distance can be obtained by calculation at the vehicle control device 7. The in-vehicle information device 5 obtains a travelling direction, a recommended travel route and the destination of the electric vehicle from the navigation device 6.

At the candidate station obtaining step S3, the in-vehicle information device 5 sends the information on current vehicle position to the station control network 1 to require information of the battery charge stations nearby from the current position of the vehicle. Upon receiving such request, the station control network 1 sends back the information on the candidate stations for battery charge and the candidate battery charge facilities therein to the in-vehicle information device 5. The information on the candidate stations includes at least the positions and other information, such as operating hours and nearby amusement or shopping facilities may be included in such information. The information on the candidate battery charge facilities includes at least a waiting time until a charge facility becomes available and battery charge fee and other information, such as the time needed for battery charge may be included. If one candidate station includes a plurality of candidate charge facilities, the information on the waiting time may be determined considering the plural facilities as a whole or may be determined per facility. When the waiting time is indicated as “zero (0)”, this means that the candidate station or the candidate facility is vacant.

Upon receipt of information on the candidate battery charge stations and the candidate charge facilities, the in-vehicle information device 5 then narrows down the number thereof in a list as the following way: first, excluding the candidate stations located relatively far away from the vehicle current position from the list in order to avoid fears of imminent battery shortage considering the estimated possible travel distance, then excluding the candidate stations which need a wide circle or detour to reach thereto from the list considering the vehicle travel direction, destination and the recommended travel route, next obtaining the necessary travel distance from the current position to each of the remaining candidate stations based on the information on the vehicle current position and the location of the remaining candidate stations by the navigation device 6, then calculating estimate taking time to arrive to the destination by dividing the necessary travel distance by the average vehicle speed to estimate the scheduled arrival time for estimating the arrival time and finally estimating an expected waiting time which may actually occur at the candidate station by subtracting the estimate taking time to arrive from the waiting time at the candidate battery charge station obtained by the wireless communication.

At the candidate station displaying step S4, the information on the candidate stations and the facilities thereof remaining in the candidate list are displayed on the display portion 53 of the in-vehicle information device 5. As the information on the candidate station, the display portion 53 displays the information on the position of the station and as the information on the charge facility therein, the display portion 53 displays an expected waiting time and the charge fee. As such display, the geographic information of navigation device 6 is used and as the screen display, symbol marks which are good for visibility are used. Further, the facilities such as shopping malls or amusement places located nearby the station are also displayed on the screen with symbol marks. For the information on the nearby facilities, the information received from the station control network 1 may be used or the information housed in the navigation device 6 may be used.

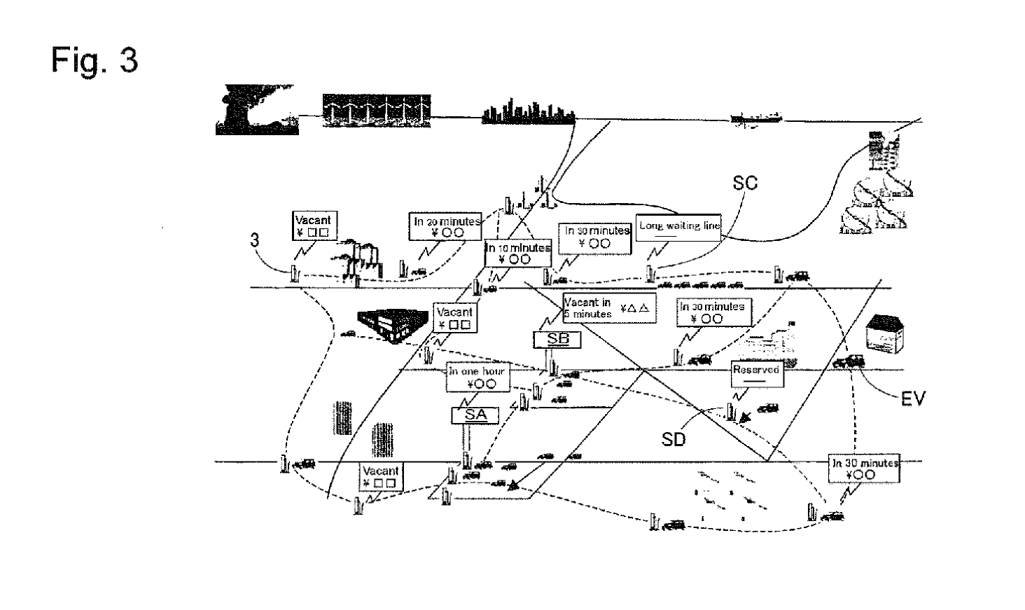

FIG. 3 shows an example of screen display which is displayed on the screen of the in-vehicle information device 5. FIG. 3 is an example of screen display of the display portion 53. The electric vehicle equipped with the in-vehicle information device 5 is indicated as EV with a large vehicle symbol and a plurality of travel routes to the candidate stations is indicated with a plurality of broken lines. In the lower side at the central portion of the drawing, battery charge stations SA and SB having three charge facilities 3 in each station are illustrated. Other stations have one facility 3 in each station.

In each battery charge station, the expected waiting time and the battery charge fee are indicated in a rectangular box. In the station SA, the indication in the box says “in an hour, ¥◯◯” and in the stationSB, the indication says “will be vacant in 5 minutes, ¥ΔΔ.”. Further, in the stationSC, the indication says “long waiting line, - - - ” which means many other electric vehicles are already in line for waiting charge to be made and in the station SD, the indication says “reserved by others, - - - ” which means the charge facility has been reserved by other users of the vehicles. The station where no battery charge performed and no reservation is made at present time says “vacant, ¥”.

At the candidate station selecting step S5, when an operator of the electric vehicle looks at the indication of position of the candidate station, the expected waiting time thereof and battery charge fee as shown in FIG. 3, the operator selects one candidate station which he or she desires to have the battery charged, considering these indications. The selection of the desired station may be made considering the factors other than the indications shown in FIG. 3, which are, such as, battery charge condition of the in-vehicle battery 8, estimate possible travel distance, nearby facilities and later explained battery charge history information. The operator then decides and sets the candidate battery charge station by operating the setting portion 54 of the in-vehicle information device 5.

At the battery charge reserving step S6, the information on a candidate charge station is sent to the station control network 1 from the in-vehicle information device 5 for requesting reservation of the battery charge. At this time, as a guide for the time actually taking for battery charge at the battery charge facility 3, the estimate taking time for arrival information is also sent to the station control network 1. The station control network 1 which has received the reservation request accepts the reservation request, using scheduling function of the station control device of the candidate battery charge station. Further, in case of some waiting time being expected, such acceptance of reservation request may include a charge starting time as a condition. If extremely longer waiting time is expected, the reservation is judged not to be accepted.

At the reservation confirming step S7, the station control network 1 sends the reservation confirmation information which indicates whether a reservation has been accepted or not to the in-vehicle information device 5. The reservation confirmation information includes the charge starting time as a condition of acceptance. Upon receipt of the reservation confirmation information, the in-vehicle information device 5 displays the received information on the display portion 53 to let the operator know whether the reservation has been accepted or not.

Thereafter, the electric vehicle arrives at the reserved battery charge station and in step S8, the in-vehicle battery 8 is charged at the charge facility 3 in the station. While battery is being charged, the operator may spend the time at a nearby facility (shopping mall or entertainment facility) which is indicated on the display of the in-vehicle information device 5. The operator may spend the time in another way.

After the battery charge is completed, at the history accumulating step S9, the in-vehicle information device 5 memorizes in the memory portion 57 regarding the battery charge history information which includes the location of the battery charge station, nearby facilities and charge condition at the time the battery charging is started. Thus memorized charge history information can be referenced when selecting a candidate station in next time at the candidate station selecting step S5.

Further, at the history disclosing step S10, the battery charge history information on various conditions for battery charge is disclosed to the outside. The procedure of disclosing the information may be made by the operator of the station through the station control network 1 or may be made at a user side of the station. The disclosure is made every time when the battery charge is performed or may be collectively made in one time after certain information has been accumulated. The content of disclosing items may not necessarily correspond to the information accumulated in the in-vehicle information device 5. The extent of information to be disclosed may be modified considering the personal information protection. Further, the user side has the right to decide whether disclosure is made or not and the user may decide at the charge facility whether disclosure is made or not and the business operator of the facility may disclose based on the user's intention.

According to the embodiment of the invention, the method for reserving the battery charge for the electric vehicle includes a candidate station displaying step S4 for displaying the candidate stations on the display portion 53 of the in-vehicle information device 5, a candidate station selecting step S5 for selecting a particular candidate station and a battery charge reserving step S6 for reserving the battery charge at the selected station. Thus, an operator of the electric vehicle can easily select a suitable battery charge station based on the travel distance to the station, expected waiting time at the charge facility and the fee for battery charge. Further, the operator of the vehicle can reserve the battery charge at a place where the operator's own intention or preference or appreciation to improve the convenience. Still further, actual risks and mental anxieties derived from a low battery charge can be relieved. The readiness and operation reliability of the station control network 1 can be improved compared to the conventional systems by sharing some part of the procedure having been performed at the network side hitherto with the vehicle side.

Further, at the candidate station obtaining step S3, since the battery charge condition of the in-vehicle battery 8 and the estimated possible travel distance can be referred to, the candidate stations which are relatively away from the current vehicle position thereby the vehicle being running into imminent battery shortage can be removed from the candidate list to narrow down the number thereof. Further, by referencing to the average vehicle speed, the travel time to the station and the arrival time thereat can be estimated and accordingly, the operator of the vehicle can reserve the battery charge presuming the time zone for performing the battery charge. Further, by referring to the vehicle travel direction, destination and recommended travel route, the operator of the vehicle can select a station by avoiding a wide circle or detour. Considering the above total effects of the embodiment, a battery charge station suitable for battery charge can be selected and the battery charge can be suitably reserved. At the reservation confirming step S7, the reservation can be confirmed whether the requested reservation is accepted or not and if the reservation is not accepted, another try of reservation can be made until the battery charge station and the facility thereof can be surely reserved.

Further, at the history accumulating step S9, since the charge history of past can be considered, the operator of the vehicle can select a battery charge station which matches with the operator's preference and which operator can decide by its own decision. In addition, at the history disclosing step S10, the information on the past battery charge dates, each user's results of the battery charge, how the users judge the timing of battery charge based on the battery charge condition and preference of nearby facilities is disclosed to outside. On the other hand, a business operator of the battery charge station including battery charge facilities may make a plan for a new opening of such station or facility or strengthen thereof and price setting of the battery charge so that the services of battery charge can be improved. This eventually expands the applicable range of the station control network 1, realizes the price down of the charge fee and improves the convenience. The value of the network can be increased which extremely contributes to the popularization of the electric vehicle and development of the battery charge business.

It is noted that a software which executes the steps S1 through S7, S9 and S10 illustrated in FIG. 2 is memorized in the memory portion 57 of the in-vehicle information device 5 and when the software executes the above steps, the means for position confirmation, vehicle state confirmation, candidate station obtaining, candidate display, candidate selection, battery charge reservation, reservation confirmation, history accumulation and history disclosure are realized to form the device for battery charge reservation for an vehicle according to the invention.

According to the method for battery charge reservation for an electric vehicle according to the embodiment of the invention, the in-vehicle information device 5 obtains current position information and geographic information from the navigation device 6. Accordingly, the in-vehicle information device 5 does not necessarily include GPS (Global Positioning System) function and geographic information to avoid duplication of equipment. This can save resources of the hardware as well as the software.

According to the embodiment of the invention, the candidate station obtaining step S3 and the candidate station displaying step S4 are included at the vehicle side as the previous steps for selecting and reserving the candidate station. However, using of these steps S3 and S4 is one example of the invention and various variations or modifications are possible within the scope of the invention. Further, the structure of the station control network 1 and the type of information handled thereby, the scope of common function use of the in-vehicle information device 5 with the navigation device 6 and display and setting method or means may be varied or modified.

### INDUSTRIAL APPLICABILITY

The method for reserving the battery charge for an electric vehicle according to the invention can be applicable to the reservation system for a public use battery charge station. Further, the device for reserving the battery charge for an electric vehicle according to the invention can be applicable to a public use battery charge station and an electric vehicle. Further, according to the invention the electric vehicle is not limited to the narrowly defined electric vehicle, but the electric vehicle according to the invention includes hybrid type vehicle which uses the fuel in addition to the electricity.

According to a first aspect of the embodiment of the invention, the method for battery charge scheduling for an electric vehicle EV by using a station control network 1 formed by a plurality of station control devices 2A through 2C which control a battery charge facility 3 equipped in a battery charge station SA through SC to mutually exchange information among the plurality of station control devices, each of which is cooperatively associated with one another and an in-vehicle information device 5 equipped in the electric vehicle for information exchange with the station control network 1 is comprised of the following steps: a position confirming step S1 for confirming a current position of the electric vehicle by the in-vehicle information device 5, a candidate battery charge station obtaining step S3 for listing up candidate battery charge stations based on the current position of the electric vehicle and obtaining information including position of the candidate battery charge station and information including a waiting time and a battery charge cost of a candidate battery charge facility 3 located in a corresponding candidate battery charge station Sa, SB and SC from the station control network 1 into the in-vehicle information device 5, a candidate battery charge station displaying step S4 for displaying the information of the candidate battery charge stations and the information of the candidate battery charge facilities 3 by the in-vehicle information device 5, a candidate battery charge station selecting step S5 for selecting a candidate battery charge station at which a battery charge is desired to be carried out and setting a selected candidate battery charge station in the in-vehicle information device 5 and a battery charge reserving step S6 for reserving the battery charge at the candidate battery charge station through the station control network 1 based on a setting at the candidate battery charge station selecting step S5 through the in-vehicle information device.

According to the method for charge scheduling for an electric vehicle according to the first aspect of the embodiment, since candidate battery charge stations SA, SB and SC can be listed up based on a current position of the electric vehicle, a user of the electric vehicle can select a desired candidate station therefrom by using the in-vehicle information device 5 and reserve the battery charge at the desired candidate station. According to the method, the user can easily select a battery charge station suitable for him or her referring to the distance to the station from the current position of the vehicle, waiting time and charge cost at the candidate stations. Further, the user can reserve the battery charge at the charge station where the user's preference is reflected to improve convenience. In addition, actual risk of battery shortage and psychological fear therefor can be overcome. Still further, since a part of processing conventionally carried out at the system side can be processed at the vehicle side, the responsibility and operation reliability can be improved.

According to a second aspect of the embodiment of the invention, the method is characterized in that a vehicle condition confirming step S2 is further included before the position confirming step S1 or thereafter for confirming at least one of items of an in-vehicle battery charge condition, an estimate possible travel distance, an average vehicle speed, a travelling direction, a recommended travel route and a destination of the electric vehicle, whereby at the candidate battery charge station obtaining step S3, the listed number of the candidate battery charge stations is lessened referring to the at least one of the above items.

According to the second aspect of the embodiment of the invention, since the candidate battery charge stations SA through SC are selected and listed up considering at least one of the items of a battery charge condition of the in-vehicle battery 8, an estimate possible travel distance, an average vehicle speed, a travelling direction, a recommended travel route and a destination of the electric vehicle, the battery charge station where the battery charge is carried out can be properly selected and the battery charge reservation can be properly made. For example, a suitable battery charge station where a battery charge is needed in good timing can be selected while travelling considering the battery charge condition of the in-vehicle battery 8 or the estimated possible travel distance. Further, by considering the average vehicle speed, the scheduled arrival time to a battery charge station is estimated to reserve a battery charge at the station at a suitable time zone. Further, by considering at least one of the items of the travelling direction, recommended travel route and destination of the electric vehicle, a suitable battery charge station can be selected without making a wide circle or detouring.

According to a third aspect of the embodiment of the invention, a reservation confirming step S7 is further included after the battery charge reserving step S6, wherein the reservation confirming step S7 obtains reservation confirmation information which indicates whether the station control network 1 has accepted a reservation at the battery charge reserving step S6 or not through the station control network and displays the reservation confirmation information on the in-vehicle information device 5.

According to the third aspect of the embodiment of the invention, the reservation confirmation information whether a reservation from a user has been accepted or not by the station control network 1 can be obtained and the obtained information can be displayed by the in-vehicle information device 5. Accordingly, the user can surely make a reservation at the charge station by referring to the information on the display, even when the first try failed.

According to a fourth aspect of the embodiment of the invention, the method is characterized in that a history accumulating step S9 is further included for accumulating a battery charge history information which includes at least one of items of a position of a battery charge carried out station, a near-by facility of the battery charge carried out station and a battery charge condition of the in-vehicle battery 8 at the time of carrying out the battery charge, and the battery charge history information is referred to in at least one of the candidate battery charge station obtaining step, S3 the battery charge station displaying step S4 and the candidate battery charge station selecting step S5.

According to the fourth aspect of the embodiment of the invention, the history of battery charge information including at least one of the items of a position of a battery charge carried out station, a near-by facility of the battery charge carried out station and a battery charge condition of the in-vehicle battery 8 at the time of battery charge is accumulated and referred to. Accordingly, the user can narrow down the number of candidate battery charge stations to select a suitable station by considering the charge history information which has been accumulated by the user. For example, a frequently used favorite charge station can be displayed as a preference or favorite candidate. Further, the candidate charge stations can be selected and displayed according to a user's tendency of decision, such as whether the user prefers to charge the battery within a relatively sufficient time to battery shortage or whether the user continues to travel immediately before the time for battery shortage. Still further, the method of the invention can satisfy the preference of the user of the electric vehicle who normally charges the battery at the station located near a shopping mall by displaying a battery charge station located near al shopping mall of the same or similar type as a preferred candidate station.

According to a fifth aspect of the embodiment of the invention, a history disclosing step S10 is included for disclosing the battery charge history information on the battery charge at the time of carrying out thereof.

According to the fifth aspect of the embodiment of the invention, the history of the battery discharge information is disclosed. In other words, the recorded battery charge information, tendency of decision for the timing of battery charge and preference information regarding to the adjacent facilities of individual users can be disclosed. On the other hand, a business operator who owns the battery charge station can improve the services by considering battery charge fee schedule or scheduling an opening of a new battery charge station or enhancing of the existing facility by referring to such disclosed information. This can widen the applicability of the station control network 1 to realize and perform the cost reduction and improvement in convenience. This can eventually heighten the network existing value and contribute to the popularization of the electric vehicle and development of battery charge station business.

According to a sixth aspect of the embodiment of the invention a device for battery charge scheduling for an electric vehicle by using a station control network 1 formed by a plurality of station control devices 2A through 2C which control a battery charge facility 3 equipped in a battery charge station SA through SC to mutually exchange information among the plurality of station control devices 2A through 2C which is cooperatively associated with one another and an in-vehicle information device 5 equipped in the electric vehicle EV for information exchange with the station control network 1, comprises a position confirming device 51 for confirming a current position of the electric vehicle by the in-vehicle information device 5, a candidate battery charge station obtaining device S3 for listing up candidate battery charge stations based on the current position of the electric vehicle and obtaining information including position of the candidate battery charge station and information including a waiting time and a battery charge cost of a candidate battery charge facility 3 located in a corresponding candidate battery charge station from the station control network 1 into the in-vehicle information device 5, a candidate battery charge station displaying device 53 for displaying the information of the candidate battery charge stations and the information of the candidate battery charge facilities 3 by the in-vehicle information device 5, a candidate battery charge station selecting device S5, 54 for selecting a candidate battery charge station at which a battery charge is desired to be carried out and setting a selected candidate battery charge station in the in-vehicle information device 5 and a battery charge reserving device S6 for reserving the battery charge at the candidate battery charge station through the station control network based on a setting by the candidate battery charge station selecting device S5 through the in-vehicle information device.

According to the sixth aspect of the embodiment of the invention, the device for scheduling battery charge for an electric vehicle is formed by a station control network 1 and an in-vehicle information device 5.

According to a seventh aspect of the embodiment of the invention, the device for battery charge scheduling for the electric vehicle is characterized in that the information exchange between the station control network 1 and the in-vehicle information device 5 is carried out through a wireless communication 52 and the in-vehicle information device 5 includes an antenna 52A used for the wireless communication. The antenna 52A is housed in a door handle 52B of the vehicle EV.

According to the seventh aspect of the embodiment of the invention, information between the station control network 1 and the in-vehicle information device 5 is exchangeable by wireless communication 52 and the in-vehicle information device 5 includes an antenna 52A for wireless communication. The antenna is housed in a door handle of the vehicle. This antenna can be commonly used with other wireless communication adopted devices such as for example a smart entry system of the vehicle thereby to contribute to rationalization of a plurality of wireless communication adopted devices equipped with the vehicle and therefore to the reduction of cost thereof.

According to an eighth aspect of the embodiment of the invention, the device for battery charge scheduling for the electric vehicle is characterized in that the in-vehicle information device 5 is formed integrally with an in-vehicle navigation device 6 and commonly includes the information on the current position, road information and the near-by facility information including geographic information or obtains the information on the current position, road information and the near-by facility information including geographic information from the navigation device.

According to the eighth aspect of the invention, the in-vehicle information device 5 is formed integrally with an in-vehicle navigation device 6 and shares the information on the current position, road information and facility information including geographic information or obtains the information on the current position, road information and facility information including geographic information from the navigation device. Normally the navigation device 6 is equipped with a GPS function which detects a vehicle current position and houses the geographic information including the road information and facility information. The navigation device 6 includes a function for displaying the current position on the display 53 and a function for navigating the vehicle to a predetermined set destination through the travel route thereto. Accordingly, by integrally forming the in-vehicle information device 5 with the navigation device 6 or by forming the device to be able to obtain information from the navigation device, the hardware resources and the software resources can be effectively utilized. Further, by utilizing a display and voice guidance by agent function, the position of the candidate battery charge station and the information accompanying thereby can be easily understandably displayed or guided or the setting method for reserving the battery charge or confirmation thereof can be easily made.

1. A method for battery charge scheduling for an electric vehicle by using a station control network formed by a plurality of station control devices which control a battery charge facility equipped in a battery charge station to mutually exchange information among the plurality of station control devices which is cooperatively associated with one another and an in-vehicle information device equipped in the electric vehicle for information exchange with the station control network, the method comprising the steps of
a position confirming step for confirming a current position of the electric vehicle by the in-vehicle information device;
a candidate battery charge station obtaining step for listing up candidate battery charge stations based on the current position of the electric vehicle and obtaining information including position of the candidate battery charge station and information including a waiting time and a battery charge cost of a candidate battery charge facility located in a corresponding candidate battery charge station from the station control network into the in-vehicle information device;
a candidate battery charge station displaying step for displaying the information of the candidate battery charge stations and the information of the candidate battery charge facilities by the in-vehicle information device;
a candidate battery charge station selecting step for selecting a candidate battery charge station at which a battery charge is desired to be carried out and setting a selected candidate battery charge station in the in-vehicle information device; and
a battery charge reserving step for reserving the battery charge at the candidate battery charge station through the station control network based on a setting at the candidate battery charge station selecting step through the in-vehicle information device.

2. The method for battery charge scheduling for an electric vehicle according to claim 1, wherein a vehicle condition confirming step is further included before the position confirming step or thereafter for confirming at least one of items of an in-vehicle battery charge condition, an estimate possible travel distance, an average vehicle speed, a travelling direction, a recommended travel route and a destination of the electric vehicle, whereby at the candidate battery charge station obtaining step, the listed number of candidate battery charge stations is lessened referring to the at least one of the items.

3. The method for battery charge scheduling for an electric according to claim 1, wherein a reservation confirming step is further included after the battery charge reserving step, wherein the reservation confirming step obtains reservation confirmation information which indicates whether the station control network has accepted a reservation at the battery charge reserving step or not from the station control network into the in-vehicle information device and displays the reservation confirmation information on the in-vehicle information device.

4. The method for battery charge scheduling for an electric according to claim 1, wherein a history accumulating step is further included for accumulating a battery charge history information which includes at least one of items of a position of a battery charge carried out station, a near-by facility of the battery charge carried out station and a battery charge condition of the in-vehicle battery at the time of carrying out the battery charge, and the battery charge history information is referred to in at least one of the candidate battery charge stations obtaining step, the battery charge stations displaying step and the candidate battery charge station selecting step.

5. The method for battery charge scheduling for an electric according to claim 1, wherein a history disclosing step is included for disclosing the battery charge history information on the battery charge at the time of carrying out thereof.

6. A device for battery charge scheduling for an electric vehicle by using a station control network formed by a plurality of station control devices which control a battery charge facility equipped in a battery charge station to mutually exchange information among the plurality of station control devices which is cooperatively associated with one another and an in-vehicle information device equipped in the electric vehicle for information exchange with the station control network, comprising:
a position confirming device for confirming a current position of the electric vehicle by the in-vehicle information device;
a candidate battery charge station obtaining device for listing up candidate battery charge stations based on the current position of the electric vehicle and obtaining information including position of the candidate battery charge station and information including a waiting time and a battery charge cost of a candidate battery charge facility located in a corresponding candidate battery charge station from the station control network into the in-vehicle information device;
a candidate battery charge station displaying device for displaying the information of the candidate battery charge stations and the information of the candidate battery charge facilities by the in-vehicle information device;
a candidate battery charge station selecting device for selecting a candidate battery charge station at which a battery charge is desired to be carried out and setting a selected candidate battery charge station in the in-vehicle information device; and
a battery charge reserving device for reserving the battery charge at the candidate battery charge station through the station control network based on a setting by the candidate battery charge station selecting device through the in-vehicle information device.

7. The device for battery charge scheduling for an electric vehicle according to claim 6, wherein the information exchange between the station control network and the in-vehicle information device is carried out through a wireless communication and the in-vehicle information device includes an antenna used for the wireless communication, the antenna being housed in a door handle of the vehicle.

8. The device for battery charge scheduling for an electric vehicle according to claim 6, wherein the in-vehicle information device is formed integrally with an in-vehicle navigation device and commonly includes the information on the current position, road information and the near-by facility information including geographic information or obtains the information on the current position, road information and the nearby facility information including geographic information from the navigation device.
